(19) United States
(12) Patent Application Publication
(10) Pub. No.: US 2015/0189142 A1
(43) Pub. Date: Jul. 2, 2015

(54) ELECTRONIC APPARATUS AND METHOD OF CAPTURING MOVING SUBJECT BY USING THE SAME

(71) Applicant: SAMSUNG ELECTRONICS CO., LTD., Suwon-si (KR)

(72) Inventor: Tae-hoon Kang, Hwaseong-si (KR)

(21) Appl. No.: 14/570,318

(22) Filed: Dec. 15, 2014

(30) Foreign Application Priority Data
Dec. 30, 2013 (KR) 10-2013-0167510

(51) Int. Cl. H04N 5/232; G01C 11/06

(52) U.S. Cl. CPC H04N 5/232; G01C 11/06

(57) ABSTRACT

A method of capturing a moving subject is disclosed. The method includes determining a motion detection area, detecting a motion of a subject in the motion detection area, determining whether or not a value of the motion of the subject is equal to or greater than a threshold value, and sequentially capturing the subject when the value of the motion of the subject is equal to or greater than the threshold value.

### CROSS-REFERENCE TO RELATED PATENT APPLICATIONS

This application claims the priority benefit of Korean Patent Application No. 10-2013-0167510, filed on Dec. 30, 2013, in the Korean Intellectual Property Office, the disclosure of which is incorporated by reference herein in its entirety.

### BACKGROUND

1. Field

Various embodiments of the invention relate to an electronic apparatus (e.g., a photographing apparatus) and a method of controlling the same, and more particularly, to an electronic apparatus and a method for capturing a moving subject by using the same.

2. Related Art

When it is intended to capture an image of a moving subject by using an electronic apparatus, it may be difficult to capture an image of the moving subject at the exact desired timing unless a moving timing of the moving subject is predicted in advance.

Also, when the electronic apparatus is in a self-timer mode, it is more difficult to predict the moving timing of the moving subject since the electronic apparatus performs an image capture operation immediately after a set time ends.

For example, when the electronic apparatus is in the self-timer mode and an image of a jumping person is to be captured, an image capture operation is often performed when the person is standing still or after the person has finished jumping.

### SUMMARY

Various embodiments of the invention include an electronic apparatus (e.g., a photographing or image capture apparatus) and a method of capturing a moving subject, whereby motions of the moving subject are detected in a determined motion detection area and then the moving subject is sequentially captured. Also, sequentially captured images may be displayed to a user as thumbnail images so that the user may select and obtain only images that are captured at desirable timings. Therefore, the user may capture an image of the moving subject at a desirable timing.

Additional embodiments are set forth, in part, in the description that follows and, in part, are apparent from the description, or may be learned by practice of the disclosed embodiments.

According to various embodiments, a method of capturing a moving subject includes determining a motion detection area, detecting a motion of a subject in the motion detection area, determining whether or not a value of the motion of the subject is equal to or greater than a threshold value, and sequentially capturing the subject when the value of the motion of the subject is equal to or greater than the threshold value.

According to an embodiment, the determining of the motion detection area may include determining the motion detection area on a live view screen based on user input.

According to an embodiment, the determining of the motion detection area may include detecting the subject on a live view screen and determining an area in which the subject is detected as the motion detection area.

According to an embodiment, the determining of the motion detection area may include detecting a brightness of the motion detection unit and re-determining the motion detection area when a value of the brightness is not greater than the threshold value.

According to an embodiment, the method may further include, before the detecting of the motion of the subject, setting an alarm for a preset time by using an auxiliary light.

According to an embodiment, the detecting of the motion of the subject may include detecting a local motion of the subject in the motion detection area by using a difference between histograms, a difference between edges, or interframe differences.

According to an embodiment, the detecting of the motion of the subject may include performing global motion compensation for a detected local motion.

According to an embodiment, the detecting of the motion of the subject may include calculating a value of a vertical motion of the subject by finding a vector flow of a detected local motion.

According to an embodiment, the detecting of the motion of the subject may include calculating a value of a vertical motion of the subject by using a difference image between frames.

According to an embodiment, the method may further include displaying thumbnail images of sequentially captured images, receiving a selection of at least one thumbnail image from the thumbnail images, and storing at least one image corresponding to at least one selected thumbnail image.

According to various embodiments, an apparatus that captures a moving subject includes an area determination unit that determines a motion detection area; a motion detection unit that detects a motion of a subject in the motion detection area; a motion determination unit that determines whether or not a value of the motion of the subject is equal to or greater than a threshold value; and a controller that sequentially captures the subject when the value of the motion of the subject is equal to or greater than the threshold value.

According to an embodiment, the area determination unit may determine the motion detection area on a live view screen based on user input.

According to an embodiment, the area determination unit may detect the subject on a live view screen, and may determine an area in which the subject is detected as the motion detection area.

According to an embodiment, the apparatus may further include a brightness determination unit that detects a brightness of the motion, detected by the detection unit, and may update the motion detection area when a value of the brightness is not greater than the threshold value.

According to an embodiment, the apparatus may further include an alarm controller that, before the detecting of the motion of the subject, sets an alarm for a preset time via an auxiliary light.

According to an embodiment, the motion detection unit may detect a local motion of the subject in the motion detection area by using a difference between histograms, a difference between edges, or interframe differences.

According to an embodiment, the motion detection unit may perform global motion compensation for a detected local motion.

According to an embodiment, the motion detection unit may calculate a value of a vertical motion of the subject by finding a vector flow of a detected local motion or by using a difference image generated as a difference between frames.

According to an embodiment, the controller may display thumbnail images of sequentially captured images, receive a selection of at least one thumbnail image from the thumbnail images, and store at least one image corresponding to at least one selected thumbnail image.

According to various embodiments, a non-transitory computer-readable storage medium having computer program instructions stored thereon that, when executed by a processor, causes the processor to perform the method of capturing a moving subject, is disclosed.

### BRIEF DESCRIPTION OF THE DRAWINGS

These and/or other embodiments are apparent and readily appreciated based on the following description of the embodiments, with reference to the accompanying drawings.

FIG. 1 is a schematic illustration of an electronic apparatus, according to an embodiment.

FIG. 2 is a schematic illustration of a main controller, according to an embodiment.

FIG. 3 is a flowchart illustrating a method of capturing a moving subject, according to an embodiment.

FIG. 4 is an illustration providing a context used in the description of an example method of determining a motion detection area, according to an embodiment.

FIG. 5 is a flowchart schematically illustrating an example method of detecting a motion of a subject, according to an embodiment.

FIGS. 6A and 6B are illustrations providing a context used in the description of a method of detecting a vertical motion of the subject, according to an embodiment.

FIG. 7 is a flowchart illustrating an example method of capturing the moving subject, according to an embodiment.

FIG. 8 is an illustration providing a context used in the description of an example in which sequentially captured images are displayed as thumbnail images, according to an embodiment.

FIG. 9 is a schematic illustration of a further example of the main controller, according to an embodiment.

FIG. 10 is a schematic illustration of a further method of capturing the moving subject, according to an embodiment.

FIG. 11 an illustration providing a context used in the description of the method of capturing the moving subject when there is at least one subject, according to an embodiment.

FIG. 12 is an illustration providing a context used in the description of an example of the method of capturing the moving subject during self-photography, according to an embodiment.

FIG. 13 is an illustration providing a context used in the description of an example of the method of capturing the moving subject when the motion detection area is not determined, according to an embodiment.

### DETAILED DESCRIPTION

Reference will now be made in detail to embodiments, examples of which are illustrated in the accompanying drawings, wherein like reference numerals refer to like elements throughout. In this regard, the disclosed embodiments may have different forms and should not be construed as being limited to the descriptions set forth herein. Accordingly, the embodiments are described below, with reference to the figures. As used herein, the term “and/or” includes any and all combinations of the associated listed items. Expressions such as “at least one of,” when preceding a list of elements, modify the entire list of elements and do not modify the individual elements of the list.

It is further understood that the terms “comprise,” “comprises,” and/or “comprising” used herein specify the presence of stated features or components, but do not preclude the presence or addition of various other features or components. In addition, terms such as “unit,” “-er (-or),” and “module,” disclosed in the specification, refer to an element that performs at least one function or operation, and may be implemented via hardware, firmware, software, or a combination of hardware, firmware, and software.

As used herein, the term “an embodiment” or “embodiment” of the invention refers to properties, structures, features, and the like, that are disclosed in at least one embodiment. Thus, expressions such as “according to an embodiment” do not always refer to the same embodiment.

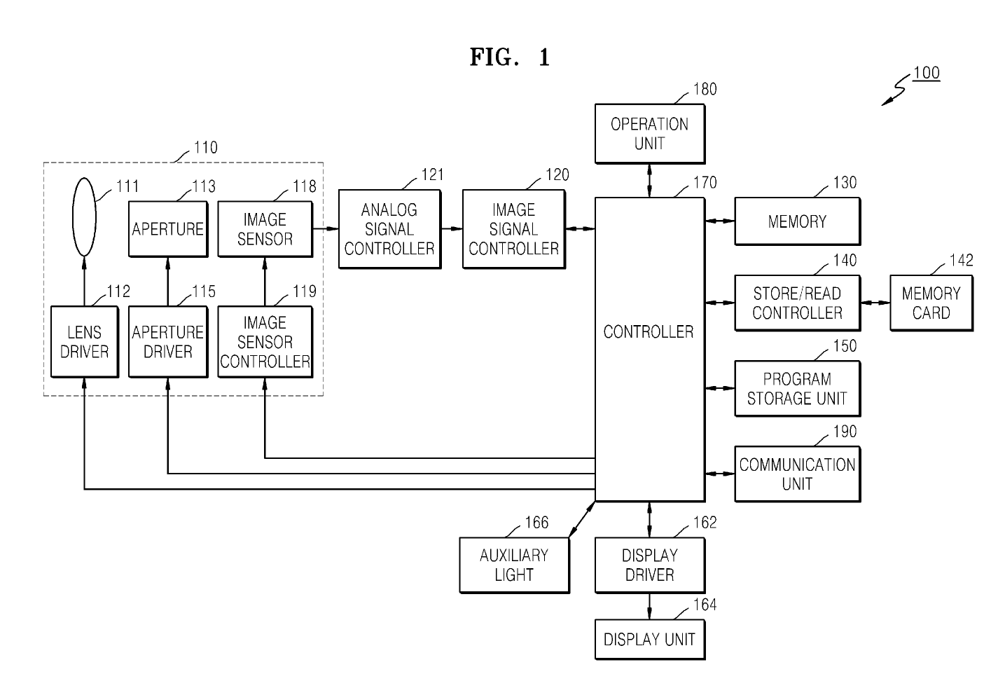

FIG. 1 is a schematic illustration of an electronic apparatus 100, according to an embodiment.

The electronic apparatus 100, according to an embodiment, may include an image capturing unit 110, an image signal controller (e.g., processor) 120, an analog signal controller (e.g., processor) 121, a memory 130, a store/read controller 140, a memory card 142, a non-transitory program storage unit 150, a display driver 162, a display unit 164, an auxiliary light 166, a main controller (e.g., processor) 170, an operation unit 180, and a communication unit 190.

The overall operation of the electronic apparatus 100 is controlled by the main controller 170. The main controller 170 generates and sends control signals to operating elements such as a lens driver 112, an aperture driver 115, and an image sensor controller 119.

The capturing unit 110 generates electric image signals from light incident thereon, and includes a lens 111, the lens driver 112, an aperture 113, the aperture driver 115, an image sensor 118, and the image sensor controller 119.

The lens 111 may include a plurality of groups of lenses or a plurality of lenses. A position of the lens 111 may be controlled by the lens driver 112 according to the control signals output by the main controller 170.

In addition, the lens driver 112 may adjust a focal distance by controlling the position of the lens 111, and may perform operations such as auto-focusing, zooming, and focus adjustment. When the lens driver 112 performs auto-focusing, the auxiliary light 166 may be used to focus exactly on a subject.

The auxiliary light 166 may include light-emitting diodes (LEDs) or a light-emitting lamp, according to an embodiment. Also, in a self-timer mode or when capturing a moving subject, the auxiliary light 166 may flash in order to notify a user that a preset time is elapsing until an image capture operation is performed.

According to an embodiment, the aperture 113, whose degree of opening is controlled by the aperture driver 115, may adjust an amount of light incident onto the image sensor 118.

Optical signals that passed through the lens 111 and the aperture 113 form an image of the subject on a light-receiving surface of the image sensor 118. The image sensor 118 may be a charged-coupled device (CCD) or a complementary metal-oxide semiconductor (CIS) image sensor that converts optical signals into electric signals, according to an embodiment. A sensitivity of the image sensor 118 may be controlled by the image sensor controller 119. The image sensor controller 119 may control the image sensor 118 in real time according to control signals that are automatically generated in response to input image signals or control signals that are manually input by the user.

According to an embodiment, the analog signal controller 121 performs noise reduction processing, gain adjustment, waveform shaping, analog-to-digital conversion, or the like on analog signals that are supplied by the image sensor 118.

According to an embodiment, the image signal processor 120 performs certain processes on image data signals that are processed by the analog signal processor 121. For example, the image signal processor 120 may reduce noise of input image data, and may perform image signal processes that improve image quality and generate special effects, such as gamma correction, color filter array interpolation, color matrix, color correction, color enhancement, white balance adjustment, brightness smoothing, and color shading. The image signal controller 120 may compress the image data to generate an image file, from which the image data may also be restored. A compression format of the image data may be reversible or irreversible. An example of a compression format of still images includes a joint photographic experts group (JPEG) or a JPEG 2000. When capturing moving images, a moving image file may be generated by compressing a plurality of frames according to a moving picture experts group (MPEG) standard. The image file may be generated according to an exchangeable image file format (Exif).

According to an embodiment, the image signal controller 120 may generate a moving image from imaging signals that are generated by the image sensor 118. The image signal controller 120 may generate frames to be included in the moving image file from the image signals, may code the frames according to a standard such as MPEG4, H.264/AVC, windows media video (WMV), etc., and may compress the frames so as to generate the moving image file. The moving image file may be generated in various formats such as mpg, mp4, 3gpp, avi, asf, mov, etc.

According to an embodiment, the image data that is output from the image signal processor 120 is input to the store/read controller 140 directly, or via the memory 130. The storage/read controller 140 may store the image data in the memory card 142 automatically, or according to a signal input by the user. The storage/read controller 140 may read the image data from the image file stored in the memory card 142, and may send the image data to the display driver 162 via the memory 130 or by another path, so as to display the image on the display unit 164. The memory card 142 may be a separable component or a built-in component of the electronic apparatus 100. For example, the memory card 142 may be a flash memory card such as a secure digital (SD) card.

According to an embodiment, the image signal controller 120 may also perform obscuring, coloring, blurring, edge enhancement, image analysis processing, image detecting processing, image effect processing, and the like. The image detection processing may be a face detection process, a scene detection process, or the like. Furthermore, the image signal controller 120 may process image signals to be displayed on the display unit 164. For example, brightness level adjustment, color correction, contrast adjustment, contour enhancement, screen division, character image generation, and image combination may be performed.

According to an embodiment, the signals processed by the image signal controller 120 may be input to the main controller 170 directly, or via the memory 130. The memory 130 may function as a main memory of the electronic apparatus 100, and may temporarily store information required during operations of the image signal processor 120 or the main controller 170. The non-transitory program storage unit 150 stores programs that control the operation of the electronic apparatus 100, such as an operation system and an application system.

According to an embodiment, the electronic apparatus 100 may include the display unit 164 that displays an operation status or information regarding an image captured by the electronic apparatus 100. The display unit 164 may display visual information and/or auditory information to the user. In order to display the visual information, the display unit 164 may include, for example, a liquid crystal display (LCD) panel or an organic light-emitting display panel. Also, the display unit 164 may be a touch screen.

According to an embodiment, the display driver 162 may send driving signals to the display unit 164.

According to an embodiment, the main controller 170 may process image signals, and control each element according to image signals or external input signals. The main controller 170 may be a single processor or a plurality of processors. The main controller 170 may be formed as an array of a plurality of logic gates or as a combination of a universal microprocessor and a memory that stores a program that may be executed by the universal microprocessor. One of ordinary skill in the art may understand that the main controller 170 may be formed by using various types of hardware or firmware.

According to an embodiment, the main controller 170 may execute programs stored in the non-transitory program storage unit 150. Alternatively, the main controller 170 may include a separate module that generates control signals that control auto-focusing, zoom ratio changing, focus shifting, auto exposure correction, or the like, and may send the control signals to the aperture driver 115, the lens driver 112, and the image sensor controller 119. Thus, the main controller 170 may control components of the electronic apparatus 100, such as a shutter and a strobe.

According to an embodiment, the main controller 170 may be connected to an external monitor (not shown), perform a predetermined process on the image signals to be displayed on the external monitor, and transmit the processed image signals so as to display the processed image signals on the external monitor.

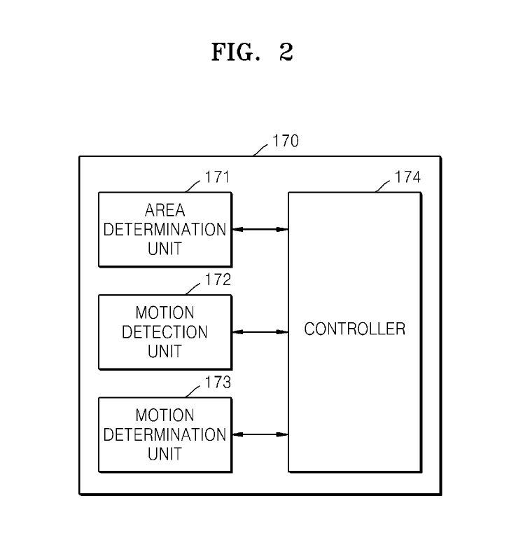

According to an embodiment, the main controller 170 may control each element of the electronic apparatus 100 to capture a moving subject. In other words, the main controller 170 may determine a motion detection area and may detect motions of the subject in the determined motion detection area. If a value of a detected motion of the subject is equal to or greater than a threshold value, sequential image capture may be performed on the subject. Details of operations performed by the main controller 170 to capture the moving subject are described below with reference to FIGS. 2-9.

According to an embodiment, a user may input control signals via the operation unit 180. The operation unit 180 may include various functional buttons, such as a shutter-release button that generates shutter-release signals to control exposure of the image sensor 118 to light for a preset time period to capture an image, a power button that generates control signals to control a power on or power off operation, a zoom button that generates signals that control widening or narrowing an angle of view according to an input, a mode selection button, and other buttons that generate signals to control adjusting capture setting values. The operation unit 180 may be implemented in any form that allows the user to input the control signals, such as buttons, a keyboard, a touch pad, a touch screen, a remote control. etc.

According to an embodiment, the communication unit 190 may include a network interface card (NIC) or a modem, and allow the electronic apparatus 100 to communicate with an external device in a network via wired or wireless connection.

According to an embodiment, the electronic apparatus 100 of FIG. 1 may be a digital single lens reflex (DSLR), a mirrorless camera, or may be integrated in a smartphone. However, the electronic apparatus 100 is not limited thereto, and may be any apparatus that includes a camera module with a lens and an electronic device that is capable of generating an image by capturing light from a subject.

FIG. 2 is a schematic illustration of the main controller 170, according to an embodiment.

Referring to FIG. 2, the main controller 170 may include an area determination unit 171, a motion detector 172, a motion determination unit 173, and a controller 174.

The area determination unit 171, according to an embodiment, may determine the motion detection area in which motions of the subject are detected. For example, the area determination unit 171 may determine the motion detection area on a live view screen based on user input. As another example, the area determination unit 171 may detect the subject on the live view screen and may determine an area in which the subject is detected as the motion detection area. As another example, the area determination unit 171 may determine the entire live view screen as the motion detection area.

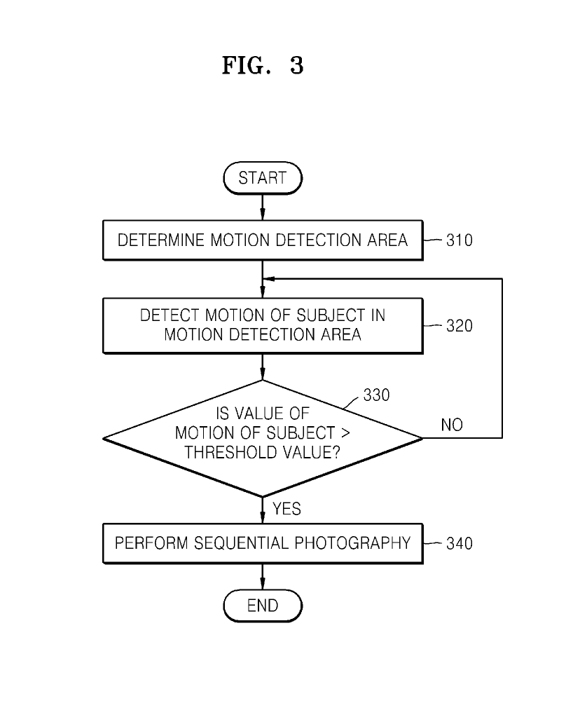

Details of determining the motion detection area are described below with reference to FIG. 3.

The motion detector 172, according to an embodiment, may detect the motions of the subject in the determined motion detection area.

For example, when the subject jumps, the electronic apparatus 100 detects a local motion in the motion detection area.

According to an embodiment, in order to detect the local motion, a difference between histograms, a difference between edges, or interframe differences may be used, but the invention is not limited thereto. Since a method of detecting a local motion between frames is well-known to one of ordinary skill in the art, detailed description thereof will be omitted. However, according an embodiment, the local motion may be detected only within the motion detection area so that reduced computing resources are used.

Since detection of the local motion may be affected by movement of the electronic apparatus 100, global motion compensation may be additionally executed in order to detect only the local motion within the motion detection area, according to an embodiment.

According to an embodiment, the local motion may be efficiently detected by adjusting the movement of the electronic apparatus 100.

According to an embodiment, the motion determination unit 173 may determine whether or not the value of the detected motion of the subject is equal to or greater than a threshold value. For example, when capturing a jumping image, in order to determine whether the motion of the subject is a jumping motion or not, the motion determination unit 173 determines whether a value of a vertical motion is equal to or greater than a threshold value. In this case, the value of the vertical motion of the subject may be calculated by finding a vector flow of a detected local motion, or by using a difference image between frames.

According to an embodiment, the controller 174 may sequentially capture the subject when the value of the motion of the subject is equal to or greater than the threshold value. Time intervals of a sequential image capture operation or the number of images captured during the sequential image capture operation may be predetermined by the user.

According to an embodiment, the controller 174 may maintain a fast shutter speed so as to avoid motion blur that may appear due to a slow shutter speed. That is, camera parameters, such as ISO setting or the aperture, may be adjusted in order to maintain a fast shutter speed depending on the image capture conditions.

According to an embodiment, after the sequential image capture operation has been performed, the controller 174 may display thumbnail images that respectively correspond to sequentially captured images, and the user may select a thumbnail image of an image captured at the most appropriate timing from the displayed thumbnail images. Only an image corresponding to a selected thumbnail image may be stored in the memory card 142.

Hereinafter, a method of capturing the moving subject, according to an embodiment, is described with reference to FIGS. 3-8.

FIG. 3 is a flowchart illustrating a method of a method of capturing the moving subject, according to an embodiment.

Referring to FIG. 3, the method of capturing the moving subject includes operations that are sequentially processed by the electronic apparatus 100 and the main controller 170 of FIGS. 1 and 2. Therefore, all of the above-described features and elements of the electronic apparatus 100 and the main controller 170 of FIGS. 1 and 2 are included in the description of the method of FIG. 3.

In operation 310, the area determination unit 171 may determine the motion detection area in which the motion of the subject is detected, according to an embodiment.

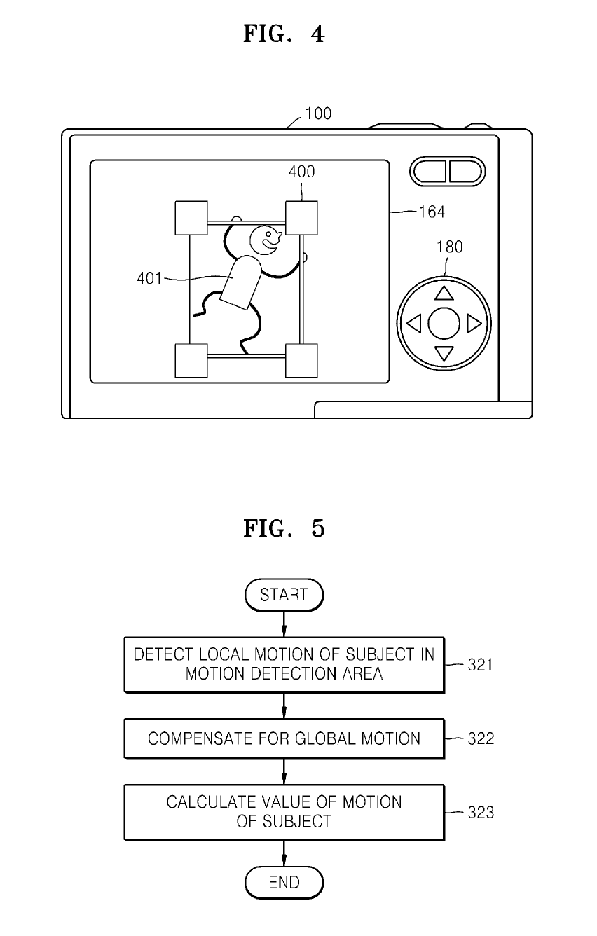

Referring to FIG. 4, which shows an example of determining a motion detection area 400 according to an embodiment, the area determination unit 171 may determine the motion detection area 400 on the display unit 164 of the electronic apparatus 100 based on user input, according to an embodiment.

For example, according to an embodiment, when the electronic apparatus 100 is in a moving subject capturing mode, the motion detection area 400 may be displayed on the display unit 164 as a square-shaped object with four vertices. In this case, the motion detection area 400 may be displayed to overlap a live view image. Also, the user may select and drag the vertices of the object to change a size thereof or may touch and drag the center of the object to move the object so that the object may include a subject 401. The motion detection area 400 may also be selected by using the operation unit 180.

As another example, according to an embodiment, the area determination unit 171 may detect the subject 401 on a live view screen, and may determine an area in which the subject is detected as the motion detection area 400. As another example, the area determination unit 171 may determine the entire live view screen as the motion detection area.

Referring back to FIG. 3, in operation 320, the motion detection unit 172 may detect the motion of the subject in the determined motion detection area, according to an embodiment.

FIG. 5 is a flowchart illustrating an example method of detecting the motion of the subject, according to an embodiment. Referring to FIG. 5, in operation 321, the motion detector 172 detects the local motion of the subject within the motion detection area 400. In order to detect the local motion, a difference between histograms of a reference image and an current image, a difference between edges of a reference image and an current image, or interframe differences may be used.

In operation 322, the motion detector 172 performs global motion compensation to the detected local motion, according to an embodiment. That is, since detection of the local motion may be affected by the movement of the electronic apparatus 100, global motion compensation may be additionally executed in order to detect only the local motion within the motion detection area.

The term “global motion” is a broad term that includes motions of a camera, e.g., panning, zooming, rotating, motions of an object, etc.

In operation 323, the motion detector 172 may calculate the value of the motion of the subject.

According to an embodiment, when capturing a jumping image, the motion detector 172 may calculate a value of a vertical motion, and may determine whether the subject has moved.

According to an embodiment, the value of the vertical motion of the subject may be calculated by finding a vector flow (or an optical flow) between frames or by using a difference image between frames.

That is, according to an embodiment, when capturing the jumping image, horizontal motions of the subject from detected motions of the subject may be neglected.

Referring back to FIG. 3, in operation 330, according to an embodiment, the motion determination unit 173 determines whether or not the value of the detected motion of the subject is equal to or greater than the threshold value. For example, when capturing a jumping image, in order to determine whether the motion of the subject is a jumping motion or not, the motion determination unit 173 may determine whether the value of the vertical motion is equal to or greater than the threshold value.

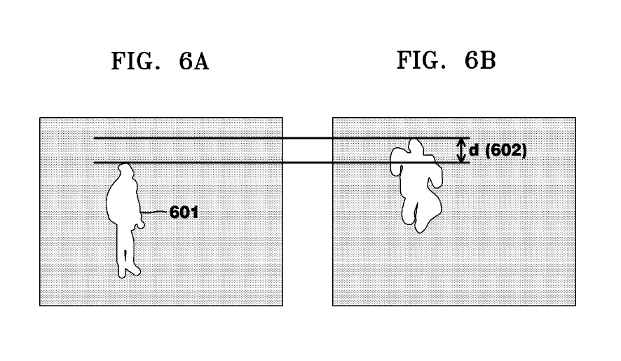

In particular, FIGS. 6A and 6B are illustrations providing a context used in the description of a method of detecting the vertical motion of the subject, according to an embodiment. In an example method of determining a direction of a motion of a subject 601 shown in FIG. 6, a value d 602 indicates a threshold value of the motion of the subject 601 in a y-axis direction. Accordingly, when the subject 601 of FIG. 6A jumps, the motion determination unit 173 may determine whether or not a value of the jump is greater than the threshold value d 602 of FIG. 6B. When the value of the jump is greater than the threshold value d 602, the motion determination unit 173 determines that a vertical motion has been performed, and thus, the sequential image capture operation may be performed. That is, motions such as hand waving or body moving of the subject 601 during the jump may be neglected. Also, when determining whether to start capturing a jumping image, motions in an x-axis direction may be neglected.

The user may hold the electronic apparatus 100 horizontally, as illustrated in FIGS. 6A and 6B, or vertically. When the user holds the electronic apparatus 100 vertically, only motions in the x-axis direction may be detected to determine whether to start capturing images.

Referring back to FIG. 3, in operation 340, the controller 174, according to an embodiment, may perform the sequential image capture operation with respect to the subject when the value of the motion of the subject is equal to or greater than the threshold value. Time intervals of the sequential image capture operation or the number of images captured during the sequential image capture operation may be predetermined by the user.

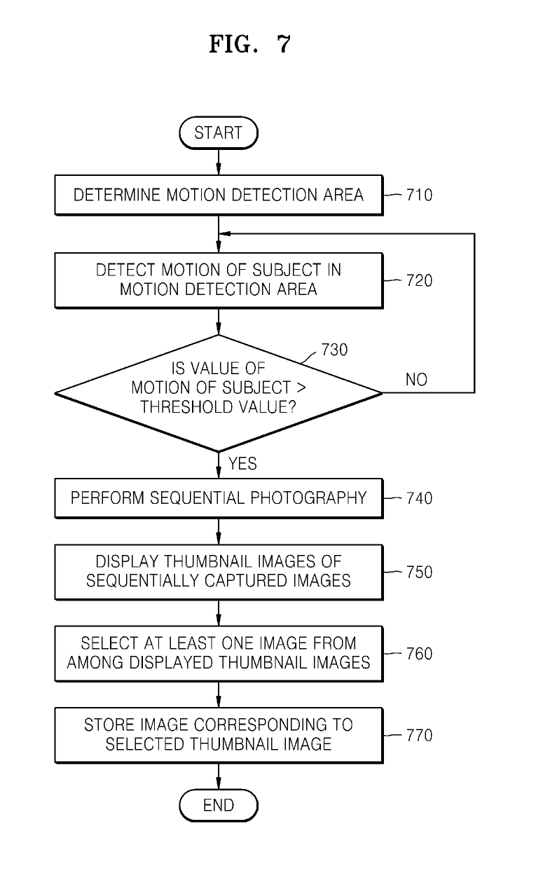

FIG. 7 is a flowchart illustrating another example of a method of capturing an image of the moving subject, according to an embodiment.

Operations 710-740 of FIG. 7, respectively, correspond to operations 310-340 of FIG. 3, and accordingly, detailed descriptions thereof are omitted.

In operation 750, after the sequential image capture operation has been performed, the controller 174 may display thumbnail images of sequentially captured images, according to an embodiment. For example, if five images are sequentially captured, the five images are stored in the memory 130, and then thumbnail images of the five images are displayed on the display unit 164.

In operation 760, according to an embodiment, the user may select a thumbnail image of an image captured at the most appropriate timing from the displayed thumbnail images. For example, if five images are sequentially captured, thumbnail images of the five images may be simultaneously displayed, and the user may select a thumbnail image from the displayed thumbnail images.

In operation 770, according to an embodiment, the controller 174 may store an image corresponding to the selected thumbnail image in the memory card 142.

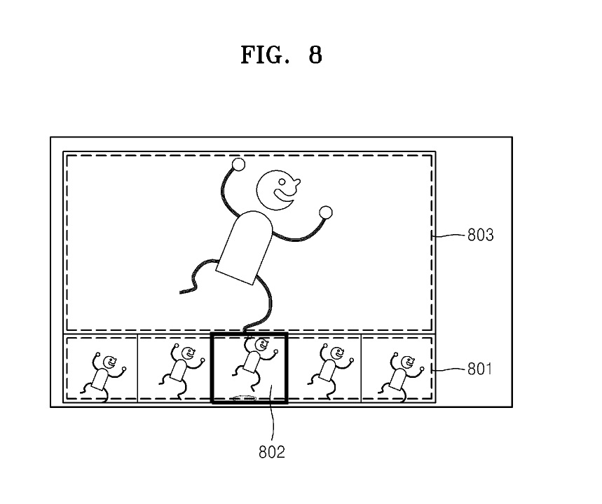

FIG. 8 is an illustration providing a context used in the description of an example in which sequentially captured images are displayed as thumbnail images, according to an embodiment.

Referring to FIG. 8, if five images are sequentially captured, the five images are stored in the memory 130, and thumbnail images of the five images may be simultaneously displayed at a side 801 of the display unit 164. In other embodiments, other numbers (1, 2, 3, 4, 6, . . . , etc.) of images may be captured, stored, displayed, etc.

When the user selects a thumbnail image 802 from the displayed thumbnail images, an enlarged image of the thumbnail image 802 may be displayed on the other side 803 of the display unit 164, according to an embodiment.

When an image to be stored is finally selected according to user input, a selected image may be stored in the memory card 142, according to an embodiment. For example, when capturing a jumping image, the user may select a captured image of a person that has jumped and reached the highest point, and the selected image may be stored with a predetermined resolution. That is, when capturing a high resolution image of 20 mega pixels, for example, a thumbnail image of the image may have a resolution of 2 mega pixels, but an image that is actually stored may have a resolution of 20 mega pixels.

Accordingly, the electronic apparatus 100 may capture an image of the moving subject at the most appropriate timing, according to an embodiment. However, the electronic apparatus 100 is not limited thereto, and sequentially captured images may be converted to and stored in an animation format (e.g., gif format), or all of the sequentially captured images may be stored.

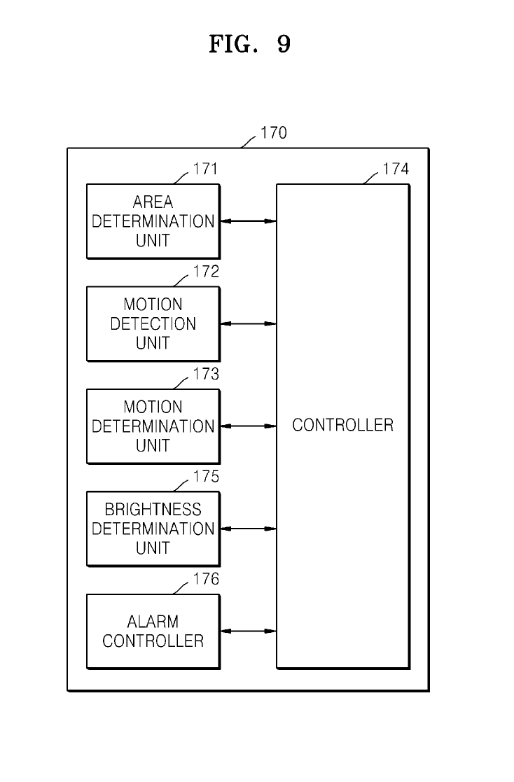

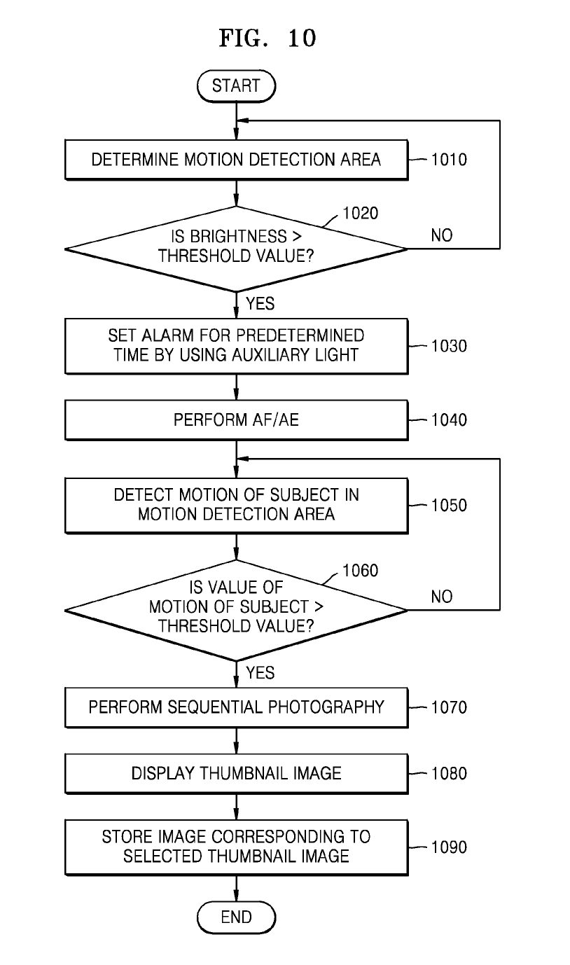

FIG. 9 is a schematic illustration of a further example of the main controller 170, according to an embodiment.

Referring to FIG. 9, the main controller 170, according to an embodiment, may include the area determination unit 171, the motion detector 172, the motion determination unit 173, the controller 174, a brightness determination unit 175, and an alarm controller 176.

Operations of the area determination unit 171, the motion detector 172, the motion determination unit 173, and the controller 174 are described above with reference to FIG. 2.

The brightness determination unit 175, according to an embodiment, detects a brightness of a motion detection area, and determines whether or not a detected brightness is lower than a predetermined threshold value. Therefore, in a low brightness state, capturing of the moving subject may be prohibited and a warning message may be displayed. In a further embodiment, the motion detection area may be re-determined. That is, since it may be difficult to determine the motion of the subject in the motion detection area in a low brightness state, the brightness of the motion detection area may be determined in advance to prevent errors in the sequential image capture operation.

According to an embodiment, the alarm controller 176 may set an alarm for a preset time by using the auxiliary light 166 before the motion detector 172 detects the motion of the subject. For example, the alarm controller 176 may control a flashing speed of the auxiliary light 166 to notify the user that a preset time is about to elapse.

As another example, according to an embodiment, the electronic apparatus 100 may further include an auxiliary display (not shown) in a front portion thereof, and may display a message instructing a user to prepare for a motion when the auxiliary light 166 emits light. In a further embodiment, user interface in a form of a progressing bar, may alert a user.

Thus, according to an embodiment, when performing an image capture operation in a self-timer mode, the subject may move into the motion detection area while the auxiliary light 166 is flashing, and when the auxiliary light 166 stops flashing, the subject may perform a motion (e.g., jumping), and then, an image of the motion may be automatically captured.

FIG. 10 is a flowchart illustrating a further example of the method of capturing the moving subject, according to an embodiment.

Referring to FIG. 10, the method of capturing the moving subject includes operations that are sequentially processed by the electronic apparatus 100 and the main controller 170 of FIGS. 1-9, according to an embodiment. Therefore, all of the above-disclosed features and elements of the electronic apparatus 100 and the main controller 170 of FIGS. 1-9 are included in, and are relevant to, the description of the method of FIG. 10.

In operation 1010, the area determination unit 171, according to an embodiment, may determine the motion detection area in which the motion of the subject is detected. The area determination unit 171 may determine the motion detection area 400 on the display unit 164 of the electronic apparatus 100 based on user input. As another example, the area determination unit 171 may detect the subject 401 (see FIG. 4) on the live view screen, and may determine the area in which the subject is detected as the motion detection area 400. As another example, the area determination unit 171 may determine the entire live view screen as the motion detection area.

In operation 1020, the brightness determination unit 175, according to an embodiment, may detect the brightness of the motion detection area, and determine whether or not the detected brightness is lower than a predetermined threshold value. Therefore, when the detected brightness is lower than the threshold value, the brightness determination unit 175 may return to operation 1010 and re-determine the motion detection area.

In operation 1030, according to an embodiment, the alarm controller 176 may set an alarm for a preset time, by using the auxiliary light 166, before the motion detector 172 detects the motion of the subject. For example, the alarm controller 176 may control the flashing speed of the auxiliary light 166 to notify the user that a preset time is about to elapse.

In operation 1040, according to an embodiment, when the alarm is set for the preset time by using the auxiliary light 166, a focus detection area and exposure are adjusted by executing auto focusing (AF)/auto exposure (AE) so as to finish preparation for photography.

Operations 1050-1090 correspond to operations 720-770 of FIG. 7, and thus, detailed description thereof are omitted.

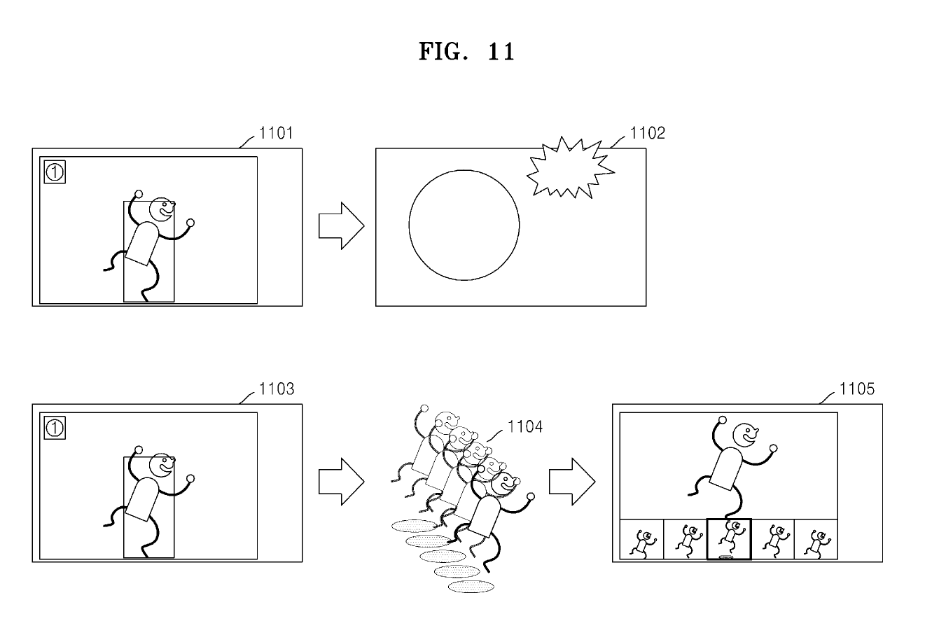

Hereinafter, examples of the method of capturing the moving subject according to an embodiment are described below with reference to FIGS. 11-13.

FIG. 11 is an illustration providing a context used in the description of an example of the method of capturing the moving subject when there is at least one subject, according to an embodiment.

Referring to FIG. 11, in operation 1101, the electronic apparatus 100 is changed to a moving subject capturing mode and determines the motion detection area according to a user setting.

In operation 1102, according to an embodiment, when the user presses a start button, the electronic apparatus 100 emits the auxiliary light 166 for a preset time. For example, the auxiliary light 166 may flash for 5 seconds.

In operation 1103, according to an embodiment, when the auxiliary light 166 stops flashing, AF/AE is executed, and thus, the motion of the subject is detected.

In operation 1104, according to an embodiment, the electronic apparatus 100 detects and determines motions in the motion detection area and performs sequential image capture operation. For example, if the subject has jumped, the electronic apparatus 100 determines that the subject has moved and sequentially captures, say, five images. In other embodiments, other number of images may be captured.

In operation 1105, according to an embodiment, the electronic apparatus 100 displays sequentially captured images as thumbnail images.

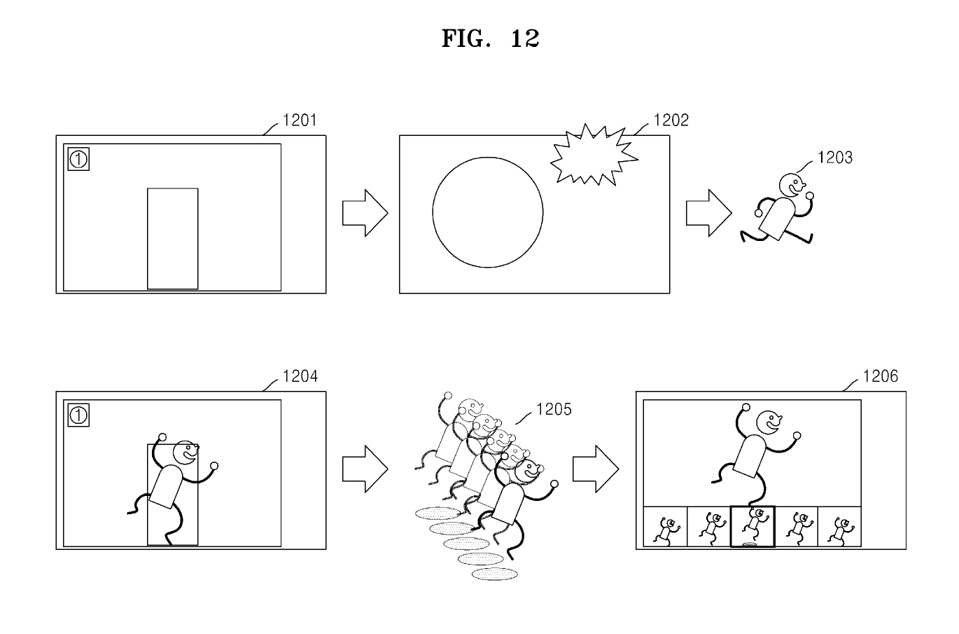

FIG. 12 is an illustration providing a context used in the description of an example of the method of capturing the moving subject during a self-photographic mode, according to an embodiment.

Referring to FIG. 12, in operation 1201, the electronic apparatus 100 is changed to the moving subject capturing mode and determines the motion detection area according to a user setting, according to an embodiment. Unlike in FIG. 11, since FIG. 12 illustrates a self-photographic mode, the user may predict his/her move and set the motion detection area accordingly.

In operation 1202, according to an embodiment, when the user presses the start button user, the electronic apparatus 100 emits the auxiliary light 166 for a preset time. For example, the auxiliary light 166 may flash for five seconds.

In operation 1203, according to an embodiment, the user may move to the motion detection area while the auxiliary light 166 is flashing. In this case, the electronic apparatus 100 may further include a tilt, swivel or front side display unit, and accordingly, the user may look at the tilt, swivel or front side display unit to determine whether he or she has moved into the motion detection area.

In operation 1204, according to an embodiment, when the auxiliary light 166 stops flashing, AF/AE is executed, and thus, the motion of the subject is detected.

In operation 1205, according to an embodiment, the electronic apparatus 100 detects and determines motions in the motion detection area and performs the sequential image capture operation. For example, if the subject has jumped, the electronic apparatus 100 determines that the subject has moved and sequentially captures, say, five images. In other embodiments, other number of images may be captured.

In operation 1206, according to an embodiment, the electronic apparatus 100 displays sequentially captured images as thumbnail images. Also, an original image that corresponds to a thumbnail image that has been selected from the displayed thumbnail images may be stored in the memory card 142.

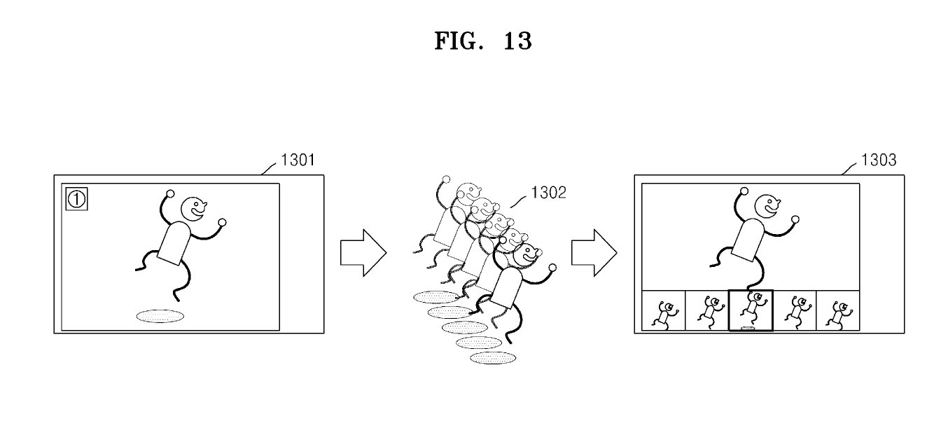

FIG. 13 is an illustration providing a context used in the description of a further example of a method of capturing the moving subject when the motion detection area is not determined.

In operation 1301, according to an embodiment, when the electronic apparatus 100 is set in the moving subject capturing mode, the electronic apparatus 100 does not determine the motion detection area and detects motions in the entire live view image.

In operation 1302, according to an embodiment, when the motion of the subject is detected, a predetermined number of images are sequentially captured.

In operation 1303, according to an embodiment, thumbnail images of the sequentially captured images are displayed. Also, an original image that corresponds to a thumbnail image that has been selected from the displayed thumbnail images may be stored in the memory card 142.

As described above, according to various embodiments, the electronic apparatus 100 may capture a moving subject at an appropriate timing by detecting motions of the moving subject in a determined motion detection area and performing a sequential image capture operation. Also, sequentially captured images may be displayed to be selected by a user so that the user may obtain images that are captured at a more exact and desirable timing.

For example, according to an embodiment, since the image capture operation may be performed only when the moving subject is actually jumping, the user may easily capture a jumping image. Also, an alarm may be set before detecting motions so that an image of a single moving subject or a plurality of moving subjects jumping may be captured at a desirable timing in a self-timer mode.

In addition, other embodiments may also be implemented through computer readable code/instructions stored in/on a non-transitory computer readable storage medium, e.g., a computer readable medium, to control at least one processing element to implement any of the above-described embodiments. The medium can correspond to any non-transitory medium/media permitting the storage and/or transmission of the computer readable code.

The computer readable code can be recorded/transferred on a non-transitory medium in various ways, with examples of the medium including recording media, such as magnetic storage media (e.g., ROM, floppy disks, hard disks, etc.) and optical recording media (e.g., CD-ROMs, or DVDs), and transmission media such as Internet transmission media.

It should be understood that the exemplary embodiments described herein should be interpreted in a descriptive sense only and not for purposes of limitation. Descriptions of features within each embodiment should typically be interpreted as available for other similar features in other embodiments.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism,” “element,” “unit,” “structure,” “means,” and “construction,” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical.” It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

While various embodiments are described with reference to the figures, it is understood by those of ordinary skill in the art that various changes in form and details may be made therein without departing from the spirit and scope as defined by the following claims.

What is claimed is:

1. A method of capturing a moving subject, the method comprising:
determining a motion detection area;
detecting a motion of a subject in the motion detection area;
determining whether or not a value of the motion of the subject is equal to or greater than a threshold value; and
sequentially capturing the subject when the value of the motion of the subject is equal to or greater than the threshold value.

2. The method of claim 1, wherein the determining of the motion detection area comprises determining the motion detection area on a live view screen based on user input.

3. The method of claim 1, wherein the determining of the motion detection area comprises:
detecting the subject on a live view screen; and
determining an area in which the subject is detected as the motion detection area.

4. The method of claim 1, wherein the determining of the motion detection area comprises detecting a brightness of the motion detection unit; and
re-determining the motion detection area when a value of the brightness is not greater than the threshold value.

5. The method of claim 1, further comprising, before the detecting of the motion of the subject, setting an alarm for a preset time by using an auxiliary light.

6. The method of claim 1, wherein the detecting of the motion of the subject comprises detecting a local motion of the subject in the motion detection area by using a difference between histograms, a difference between edges, or interframe differences.

7. The method of claim 6, wherein the detecting of the motion of the subject comprises performing global motion compensation of a detected local motion.

8. The method of claim 6, wherein the detecting of the motion of the subject comprises calculating a value of a vertical motion of the subject by finding a vector flow of a detected local motion.

9. The method of claim 6, wherein the detecting of the motion of the subject comprises calculating a value of a vertical motion of the subject by using a difference image representing image differences between frames.

10. The method of claim 1, further comprising:
displaying thumbnail images of sequentially captured images;
receiving a selection of at least one thumbnail image from the thumbnail images; and
storing at least one image corresponding to at least one selected thumbnail image.

11. An apparatus that captures a moving subject, the apparatus comprising:
an area determination unit that determines a motion detection area;
a motion detection unit that detects a motion of a subject in the motion detection area;
a motion determination unit that determines whether or not a value of the motion of the subject is equal to or greater than a threshold value; and
a controller that sequentially captures the subject when the value of the motion of the subject is equal to or greater than the threshold value.

12. The apparatus of claim 11, wherein the area determination unit determines the motion detection area on a live view screen based on user input.

13. The apparatus of claim 11, wherein the area determination unit detects the subject on a live view screen, and determines an area in which the subject is detected as the motion detection area.

14. The apparatus of claim 11, further comprising a brightness determination unit that detects a brightness of the motion detection unit and re-determines the motion detection area when a value of the brightness is not greater than the threshold value.

15. The apparatus of claim 11, further comprising an alarm controller that, before the detecting of the motion of the subject, sets an alarm for a preset time via an auxiliary light.

16. The apparatus of claim 11, wherein the motion detection unit detects a local motion of the subject in the motion detection area by using a difference between histograms, a difference between edges, or interframe differences.

17. The apparatus of claim 16, wherein the motion detection unit performs global motion compensation of a detected local motion.

18. The apparatus of claim 16, wherein the motion detection unit calculates a value of a vertical motion of the subject by finding a vector flow of a detected local motion or by using a difference image representing image differences between frames.

19. The apparatus of claim 16, wherein the controller displays thumbnail images of sequentially captured images, receives a selection of at least one thumbnail image from the thumbnail images, and stores at least one image corresponding to at least one selected thumbnail image.

20. A non-transitory computer-readable recording medium having recorded thereon a program, which, when executed by a processor, causes the processor to perform the method of claim 1.
